(19) United States
(12) Patent Application Publication
(10) Pub. No.: US 2006/0293464 A1
(43) Pub. Date: Dec. 28, 2006

(54) Highly neutralized acid polymer compositions having a low moisture vapor transmission rate and their use in golf balls

(76) Inventors: Murali Rajagopalan, South Dartmouth, MA (US); Michael J. Sullivan, Barrington, RI (US); Pamela V. Arnold, Fairhaven, MA (US); Edmund A. Hebert, Mattapoisett, MA (US); Derek A. Ladd, Acushnet, MA (US)

Correspondence Address: ACUSHNET COMPANY, 333 BRIDGE STREET, P. O. BOX 965, FAIRHAVEN, MA, 02719, US

(21) Appl. No.: 11/468,975

(22) Filed: Aug. 31, 2006

Related U.S. Application Data
(63) Continuation-in-part of application No. 11/270,066, filed on Nov. 9, 2005.
Application No. 11/270,066 is a continuation-in-part of application No. 10/959,751, filed on Oct. 6, 2004.
Application No. 10/959,751 is a continuation-in-part of application No. 10/360,233, filed on Feb. 6, 2003, now Pat. No. 6,939,907.
Application No. 10/360,233 is a continuation-in-part of application No. 10/118,719, filed on Apr. 9, 2002, now Pat. No. 6,756,436.
(60) Provisional application No. 60/301,046, filed on Jun. 26, 2001.

(51) Int. Cl. C08F 8/00; A63B 37/06; B32B 27/00

(52) U.S. Cl. 525/360; 473/371; 525/366; 525/370

(57) ABSTRACT

The present invention is directed to a golf ball having at least one layer formed from a moisture resistant composition having a moisture vapor transmission rate of 12.5 g·mil/100 in²/day or less, a melt flow index of 1.0 g/10 min or higher, and comprising a highly neutralized acid polymer. Golf balls of the present invention include one-piece, two-piece, multi-layer, and wound golf balls. The composition may be present in any one or more of a core layer, a cover layer, or an intermediate layer.

### CROSS-REFERENCE TO RELATED APPLICATIONS

This application is a continuation-in-part of U.S. application Ser. No. 11/270,066, filed Nov. 9, 2005, which is a continuation-in-part of U.S. application Ser. No. 10/959,751, filed Oct. 6, 2004, which is a continuation-in-part of U.S. application Ser. No. 10/360,233, filed Feb. 6, 2003, now U.S. Pat. No. 6,939,907, which is a continuation-in-part of U.S. application Ser. No. 10/118,719, filed Apr. 9, 2002, now U.S. Pat. No. 6,756,436, which claims priority to U.S. Provisional Application No. 60/301,046, filed Jun. 26, 2001, the entire disclosures of which are hereby incorporated herein by reference.

### FIELD OF THE INVENTION

The present invention is directed to compositions having a moisture vapor transmission rate of 12.5 g·mil/100 in²/day or less and a melt index of 1.0 g/10 min or greater and comprising a highly neutralized acid polymer. The present invention is also directed to the use of such compositions in golf balls.

### BACKGROUND OF THE INVENTION

Conventional golf balls can be divided into two general classes: solid and wound. Solid golf balls include one-piece, two-piece (i.e., solid core and a cover), and multi-layer (i.e., solid core of one or more layers and/or a cover of one or more layers) golf balls. Wound golf balls typically include a solid, hollow, or fluid-filled center, surrounded by a tensioned elastomeric material, and a cover.

Golf ball core and cover layers are typically constructed with polymer compositions including, for example, polybutadiene rubber, polyurethanes, polyamides, ionomers, and blends thereof. Ionomers, particularly highly neutralized ionomers, are a preferred group of polymers for golf ball layers because of their toughness, durability, and wide range of hardness values. However, conventional highly neutralized ionomers are hydrophilic, due to the highly hydrophilic nature of the cation sources traditionally used to neutralize the ionomers, e.g., magnesium and magnesium salts of fatty acids. As a result of their hydrophilic nature, conventional highly neutralized ionomers can absorb a significant amount of moisture, e.g., 2,000 to 10,000 parts per million (ppm), which can result in processing difficulties, such as creating voids in the part during an injection molding process, and a reduction in golf ball performance, such as decreased coefficient of restitution (“COR”) and stiffness due to the plasticization of ionic aggregates by water molecules.

Therefore, a desire remains for compositions containing highly neutralized acid polymers and having improved moisture vapor resistance properties. The present invention describes such compositions and the use thereof in a variety of golf ball core and cover layers.

### SUMMARY OF THE INVENTION

In one embodiment, the present invention is directed to a two-piece golf ball comprising a core and a cover, wherein at least one of the core and the cover is formed a moisture resistant composition. The moisture resistant composition has a moisture vapor transmission rate of 12.5 g·mil/100 in²/day or less, a melt flow index of 1.0 g/10 min (190° C., 2.16 kg) or greater, and comprises a highly neutralized polymer.

In another embodiment, the present invention is directed to a multi-layer golf ball comprising an inner core layer, an outer core layer, and a cover, wherein at least one of the inner core layer, the outer core layer, and the cover is formed from a moisture resistant composition. The moisture resistant composition has a moisture vapor transmission rate of 12.5 g·mil/100 in²/day or less, a melt flow index of 1.0 g/10 min (190° C., 2.16 kg) or greater, and comprises a highly neutralized acid polymer.

In another embodiment, the present invention is directed to a multi-layer golf ball comprising a core, an inner cover layer, and an outer cover layer, wherein at least one of the core, the inner cover layer, and the outer cover layer is formed from a moisture resistant composition. The core has a diameter of 1.50 inches, the inner cover layer has a thickness of from 0.025 inches to 0.060 inches, and the outer cover layer has a thickness of from 0.025 inches to 0.090 inches. The moisture resistant composition has a moisture vapor transmission rate of 12.5 g·mil/100 in²/day or less, a melt flow index of 1.0 g/10 min (190° C., 2.16 kg) or greater, and comprises a highly neutralized acid polymer.

### DETAILED DESCRIPTION OF THE INVENTION

Golf balls of the present invention include one-piece, two-piece, multi-layer, and wound golf balls having a variety of core structures, intermediate layers, covers, and coatings. Golf ball cores may consist of a single, unitary layer, comprising the entire core from the center of the core to its outer periphery, or they may consist of a center surrounded by at least one outer core layer. The center, innermost portion of the core is preferably solid, but may be hollow or liquid-, gel-, or gas-filled. The outer core layer may be solid, or it may be a wound layer formed of a tensioned elastomeric material. Golf ball covers may also contain one or more layers, such as a double cover having an inner and outer cover layer. Optionally, additional layers may be disposed between the core and cover.

Golf balls of the present invention have at least one layer formed from a moisture resistant composition comprising a highly neutralized polymer as disclosed herein. The moisture resistant composition can be present in any one or more of a core layer, a cover layer, or an intermediate layer disposed between the core or cover.

For purposes of the present disclosure, a composition is “moisture resistant” if it has a moisture vapor transmission rate (“MVTR”) of 12.5 g·mil/100 in²/day or less. Preferably, the composition has an MVTR of 8.0 g·mil/100 in²/day or less, or 6.5 g·mil/100 in²/day or less, or 5.0 g·mil/100 in²/day or less, or 4.0 g·mil/100 in²/day or less, or 2.5 g·mil/100 in²/day or less, or 2.0 g·mil/100 in²/day or less. As used herein, moisture vapor transmission rate (MVTR) is given in g-mil/100 in²/day, and is measured at 20° C., and according to ASTM F1249-99.

Moisture resistant compositions of the present invention comprise a highly neutralized acid polymer (“HNP”). As used herein, “highly neutralized” refers to the acid polymer after at least 70%, preferably at least 80%, more preferably at least 90%, even more preferably at least 95%, and even more preferably 100%, of the acid groups thereof are neutralized. The HNP may be neutralized by a cation, a salt of an organic acid, a suitable base of an organic acid, or any combination of two or more thereof.

Suitable HNPs are salts of homopolymers and copolymers of a,β-ethylenically unsaturated mono- or dicarboxylic acids, and combinations thereof. The term “copolymer,” as used herein, includes polymers having two types of monomers, those having three types of monomers, and those having more than three types of monomers. Preferred acids are (meth)acrylic acid, ethacrylic acid, maleic acid, crotonic acid, fumaric acid, itaconic acid. (Meth)acrylic acid is particularly preferred. As used herein, “(meth)acrylic acid” means methacrylic acid and/or acrylic acid. Likewise, “(meth)acrylate” means methacrylate and/or acrylate. Preferred acid polymers are copolymers of a C₃ to C₈ a,β-ethylenically unsaturated mono- or dicarboxylic acid and ethylene or a C₃ to C₆ a-olefin, optionally including a softening monomer. Particularly preferred acid polymers are copolymers of ethylene and (meth)acrylic acid.

When a softening monomer is included, the acid polymer is referred to herein as an E/X/Y-type copolymer, wherein E is ethylene, X is a C₃ to C₈ a,β-ethylenically unsaturated mono- or dicarboxylic acid, and Y is a softening monomer. The softening monomer is typically an alkyl(meth)acrylate, wherein the alkyl groups have from 1 to 8 carbon atoms. Preferred E/X/Y-type copolymers are those wherein X is (meth)acrylic acid and/or Y is selected from (meth)acrylate, n-butyl(meth)acrylate, isobutyl(meth)acrylate, methyl(meth)acrylate, and ethyl(meth)acrylate. More preferred E/X/Y-type copolymers are ethylene/(meth)acrylic acid/n-butyl acrylate, ethylene/(meth)acrylic acid/isobutyl(meth)acrylate, ethylene/(meth)acrylic acid/(meth)acrylate, and ethylene/(meth)acrylic acid/ethyl acrylate.

The amount of ethylene or C₃ to C₆ a-olefin in the acid copolymer is typically at least 15 wt %, preferably at least 25 wt %, more preferably at least 40 wt %, and even more preferably at least 60 wt %, based on the total weight of the copolymer. The amount of C₃ to C₈ a,β-ethylenically unsaturated mono- or dicarboxylic acid in the acid copolymer is typically within a range having a lower limit of 1 wt %, or 3 wt %, or 4 wt %, or 5 wt %, and an upper limit of 20 wt %, or 25 wt %, or 30 wt %, or 35 wt %, based on the total weight of the copolymer. The amount of optional softening comonomer in the acid copolymer is typically within a range having a lower limit of 0 wt %, or 5 wt %, 10 wt %, 15 wt %, and an upper limit of 20 wt %, or 30 wt %, or 35 wt %, or 40 wt %, or 50 wt %, based on the total weight of the copolymer.

The acid polymer may be partially neutralized prior to being neutralized to 70% and higher. Suitable partially neutralized acid polymers include, but are not limited to, Surlyn® ionomers, commercially available from E.I. du Pont de Nemours and Company; AClyn® ionomers, commercially available from Honeywell International Inc.; and Iotek® ionomers, commercially available from ExxonMobil Chemical Company.

In a particular embodiment, the acid polymer is selected from Nucrel® acid copolymers, commercially available from E.I. du Pont de Nemours and Company (such as Nucrel® 960, an ethylene/methacrylic acid copolymer); Primacor® polymers, commercially available from Dow Chemical Company (such as Primacor® XUS 60758.08L and XUS60751.18, ethylene/acrylic acid copolymers containing 13.5 wt % and 15.0 wt % acid, respectively, based on the total weight of the copolymer); and partially neutralized ionomers thereof.

Additional suitable acid polymers are more fully described, for example, in U.S. Pat. No. 6,953,820 and U.S. Patent Application Publication No. 2005/0049367, the entire disclosures of which are hereby incorporated herein by reference.

The acid polymers of the present invention can be direct copolymers wherein the polymer is polymerized by adding all monomers simultaneously, as described in, for example, U.S. Pat. No. 4,351,931, the entire disclosure of which is hereby incorporated herein by reference. Ionomers can be made from direct copolymers, as described in, for example, U.S. Pat. No. 3,264,272 to Rees, the entire disclosure of which is hereby incorporated herein by reference. Alternatively, the acid polymers of the present invention can be graft copolymers wherein a monomer is grafted onto an existing polymer, as described in, for example, U.S. Patent Application Publication No. 2002/0013413, the entire disclosure of which is hereby incorporated herein by reference.

Cations suitable for neutralizing the acid polymers of the present invention are selected from silicone, silane, and silicate derivatives and complex ligands; metal ions and compounds of rare earth elements; metal ions and compounds of alkali metals, alkaline earth metals, and transition metals; and combinations thereof. Particular cation sources include, but are not limited to, metal ions and compounds of lithium, sodium, potassium, magnesium, cesium, calcium, barium, manganese, copper, zinc, tin, rare earth metals, and combinations thereof. In a particular embodiment, the cation source is selected from metal ions and compounds of calcium, metal ions and compounds of zinc, and combinations thereof. In a particular aspect of this embodiment, the equivalent percentage of calcium and/or zinc salt(s) in the final composition is 50% or higher, or 60% or higher, or 70% or higher, or 80% or higher, or 90% or higher, based on the total salts present in the final composition, wherein the equivalent % is determined by multiplying the mol % of the cation by the valence of the cation. In another particular embodiment, the cation source is selected from metal ions and compounds of lithium, sodium, potassium, magnesium, calcium, zinc, and combinations thereof. A particular potassium-based cation source is Oxone®, commercially available from E.I. du Pont de Nemours and Company. Oxone® is a monopersulfate compound wherein potassium monopersulfate is the active ingredient present as a component of a triple salt of the formula 2KHSO₅.KHSO₄.K₂SO₄ [potassium hydrogen peroxymonosulfate sulfate (5:3:2:2)]. In another particular embodiment, the cation source is selected from metal ions and compounds of lithium, metal ions and compounds of zinc, and combinations thereof. Suitable cation sources also include mixtures of lithium and/or zinc cations with other cations. Other cations suitable for mixing with lithium and/or zinc cations to produce the HNP include, but are not limited to, the “less hydrophilic” cations disclosed in U.S. Patent Application Publication No. 2006/0106175; conventional HNP cations, such as those disclosed in U.S. Pat. Nos. 6,756,436 and 6,824,477; and the cations disclosed in U.S. Patent Application Publication No. 2005/026740. The entire disclosure of each of these references is hereby incorporated herein by reference. In a particular aspect of this embodiment, the percentage of lithium and/or zinc salts in the composition is preferably 50% or higher, or 55% or higher, or 60% or higher, or 65% or higher, or 70% or higher, or 80% or higher, or 90% or higher, or 95% or higher, or 100%, based on the total salts present in the composition. The amount of cation source used is readily determined based on the desired level of neutralization.

Moisture resistant compositions of the present invention optionally comprise one or more organic acids and/or salts thereof. Suitable organic acids are aliphatic organic acids, aromatic organic acids, saturated monofunctional organic acids, unsaturated monofunctional organic acids, multiunsaturated monofunctional organic acids, and dimerized derivatives thereof. Particularly suitable are aliphatic, monofunctional organic acids, preferably having fewer than 36 carbon atoms. Particular examples of suitable organic acids include, but are not limited to, caproic acid, caprylic acid, capric acid, lauric acid, stearic acid, behenic acid, erucic acid, oleic acid, linoleic acid, myristic acid, benzoic acid, palmitic acid, phenylacetic acid, naphthalenoic acid, and dimerized derivatives thereof. Particularly suitable organic acid salts include those produced by a cation source selected from barium, lithium, sodium, zinc, bismuth, potassium, strontium, magnesium, calcium, and combinations thereof. In a particular embodiment, the organic acid salt is selected from zinc stearate and calcium stearate. Suitable organic acids are more fully described, for example, in U.S. Pat. No. 6,756,436, the entire disclosure of which is hereby incorporated herein by reference.

Moisture resistant compositions of the present invention optionally contain one or more additives and/or one or more fillers. Suitable additives include, but are not limited to, blowing and foaming agents, optical brighteners, coloring agents, fluorescent agents, whitening agents, UV absorbers, light stabilizers, defoaming agents, processing aids, mica, talc, nanofillers, antioxidants, stabilizers, softening agents, fragrance components, plasticizers, impact modifiers, acid copolymer wax, and surfactants. Suitable fillers include, but are not limited to, inorganic fillers, such as zinc oxide, titanium dioxide, tin oxide, calcium oxide, magnesium oxide, barium sulfate, zinc sulfate, calcium carbonate, zinc carbonate, barium carbonate, mica, talc, clay, silica, lead silicate, and the like; high specific gravity metal powder fillers, such as tungsten powder, molybdenum powder, and the like; regrind, i.e., core material that is ground and recycled; and nano-fillers. Filler materials may be dual-functional fillers, for example, zinc oxide (which may be used as a filler/acid scavenger) and titanium dioxide (which may be used as a filler/brightener material). Further examples of suitable fillers and additives include, but are not limited to, those disclosed in U.S. Patent Application Publication No. 2003/0225197, the entire disclosure of which is hereby incorporated herein by reference.

Moisture resistant compositions of the present invention optionally contain one or more non-fatty acid melt flow modifiers. Suitable non-fatty acid melt flow modifiers include polyamides, polyesters, polyacrylates, polyurethanes, polyethers, polyureas, polyhydric alcohols; and combinations thereof. Additional melt flow modifiers, suitable for use in compositions of the present invention, include those described in copending U.S. Patent Application Publication No. 2006/0063893 and U.S. patent application Ser. No.11/216,726, the entire disclosures of which are hereby incorporated herein by reference.

In some embodiments, moisture resistant compositions of the present invention further comprise an impact modifier. Suitable impact modifiers include, but are not limited to, homopolymers and copolymers of alkyl (meth)acrylate, metallocene-catalyzed grafted and non-grafted polymers, and epoxy acrylates.

Moisture resistant compositions of the present invention are optionally produced by blending the HNP with one or more additional polymers, such as thermoplastic polymers and elastomers. Examples of thermoplastic polymers suitable for blending with the invention HNPs include, but are not limited to, polyolefins, polyamides, polyesters, polyethers, polyether-esters, polyether-amides, polyether-urea, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, ionomers and ionomeric precursors, acid homopolymers and copolymers, conventional ionomers and HNPs (e.g., ionomeric materials sold under the trade names DuPont® HPF 1000 and DuPont® HPF 2000, commercially available from E.I. du Pont de Nemours and Company), rosin-modified ionomers, bimodal ionomers, polyurethanes, grafted and non-grafted metallocene-catalyzed polymers, single-site catalyst polymerized polymers, high crystalline acid polymers, cationic ionomers, epoxy-functionalized polymers, anhydride-functionalized polymers, and combinations thereof. Particular polyolefins suitable for blending include one or more, linear, branched, or cyclic, C₂-C₄₀ olefins, particularly polymers comprising ethylene or propylene copolymerized with one or more C₂-C₄₀ olefins, C₃-C₂₀ a-olefins, or C₃-C₁₀ a-olefins. Particular conventional HNPs suitable for blending include, but are not limited to, one or more of the HNPs disclosed in U.S. Pat. Nos. 6,756,436, 6,894,098, and 6,953,820, the entire disclosures of which are hereby incorporated herein by reference. Examples of elastomers suitable for blending with the invention polymers include natural and synthetic rubbers, including, but not limited to, ethylene propylene rubber (“EPR”), ethylene propylene diene rubber (“EPDM”), hydrogenated and non-hydrogenated styrenic block copolymer rubbers (such as SI, SIS, SB, SBS, SIBS, and the like, where “S” is styrene, “I” is isobutylene, and “B” is butadiene), butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, polybutadiene rubber, and thermoplastic vulcanizates. Additional suitable blend polymers include those described in U.S. Pat. No. 5,981,658, for example at column 14, lines 30 to 56, and in U.S. Patent Application Publication No. 2005/0267240, for example at paragraph [0073], the entire disclosures of which are hereby incorporated herein by reference. The blends described herein may be produced by post-reactor blending, by connecting reactors in series to make reactor blends, or by using more than one catalyst in the same reactor to produce multiple species of polymer. The polymers may be mixed prior to being put into an extruder, or they may be mixed in an extruder.

The present invention is not limited by any particular method or any particular equipment for making the moisture resistant composition. In a preferred embodiment, the composition is prepared by the following process. An acid polymer is fed into a melt extruder, such as a single or twin-screw extruder. A suitable amount of cation source, preferably selected from ions and compounds of Ca and/or Zn, is added to the molten polymer, such that at least 70% of all acid groups present are neutralized, including the acid groups of the acid polymer and the acid groups of the optional organic acid. Preferably at least 80%, more preferably at least 90%, more preferably at least 95%, and even more preferably at least 100%, of all acid groups present are neutralized. The acid polymer may be partially neutralized prior to contact with the cation source, preferably with a cation source selected from metal ions and compounds of Ca and/or Zn. The resulting mixture is intensively mixed prior to being extruded as a strand from the die-head. Additional materials such as additives, fillers, melt flow modifiers, and impact modifiers, are optionally incorporated during the process.

Further examples of suitable moisture resistant compositions include, but are not limited to, compositions containing an HNP neutralized by a less hydrophilic cation source as disclosed in U.S. Patent Application Publication No. 2006/0106175, the entire disclosure of which is hereby incorporated herein by reference.

In order to be processable, the moisture resistant composition of the present invention has a melt flow index of at least 0.5 g/10 min (190° C., 2.16 kg). Preferably, the melt flow index of the moisture resistant composition is at least 0.8 g/10 min, or within the range having a lower limit of 0.8 or 1.0 g/10 min, and an upper limit of 4.0 or 5.0 or 10.0 g/10 min. For purposes of the present disclosure, melt flow index is measured according to ASTM D1238.

Moisture resistant compositions of the present invention can be used in a variety of applications. For example, moisture resistant compositions containing HNPs are suitable for use in golf equipment, including, but not limited to, golf balls, golf shoes, and golf clubs.

Golf balls of the present invention can be wound, one-piece, two-piece, or multi-layer balls, wherein one or more layers are formed from a moisture resistant composition comprising a highly neutralized acid polymer and having a melt index of 1.0 g/10 min or greater. In golf balls having two or more layers which comprise such moisture resistant composition, the composition of one layer may be the same or a different composition as another layer. The layer(s) comprising the moisture resistant composition can be any one or more of a core layer (such as a center or an outer core layer), an intermediate layer, or a cover layer. Compositions of the present invention can be either foamed or filled with density adjusting materials to provide golf balls having modified moments of inertia.

Golf balls of the present invention generally have a coefficient of restitution (“COR”) of 0.800 or higher, and preferably have a COR of from 0.800 to 0.814. Golf balls of the present invention generally have a compression of 100 or less and preferably have a compression of from 80 to 90.

Golf ball cores of the present invention can be single-, dual-, or multi-layer cores and generally have an overall diameter of from 1.50 inches to 1.62 inches, and preferably have an overall diameter of 1.50 inches. Dual-layer cores of the present invention generally have a inner core layer (or “center”) having a diameter of from 0.50 inches to 1.55 inches and an outer core layer having a thickness of from 0.03 inches to 0.25 inches. Golf ball covers of the present invention can be single-, dual-, or multi-layer covers. Single-layer covers of the present invention generally have a thickness of from 0.025 inches to 0.090 inches. Each layer of dual- and multi-layer covers of the present invention generally has a thickness of from 0.025 inches to 0.060 inches.

The present invention is not limited by any particular process for forming the golf ball layers. It should be understood that the layers can be formed by any suitable technique, including injection molding, compression molding, casting, and reaction injection molding. Preferably, thermoset cover materials are formed into golf ball cover layers by casting or reaction injection molding and thermoplastic cover materials are formed into golf ball cover layers by compression or injection molding techniques.

In a preferred embodiment, the present invention provides a two-piece golf ball having a compression molded rubber core and an injection or compression molded cover layer which comprises a moisture resistant composition as described herein.

In another preferred embodiment, the present invention provides a two-piece golf ball having a core and a polyurethane or polyurea cover, wherein the core comprises a moisture resistant composition as described herein.

In another preferred embodiment, the present invention provides a multi-layer golf ball comprising an inner core layer, an outer core layer, and a cover having one or more layers. At least one of the inner core layer and the outer core layer comprises a moisture resistant composition as described herein.

In another preferred embodiment, the present invention provides a multi-layer golf ball comprising a core having one or more layers, an inner cover layer, and an outer cover layer. At least one of the inner cover layer and the outer cover layer comprises a moisture resistant composition as described herein.

Golf balls of the present invention may have at least one layer formed from a composition other than the moisture resistant composition disclosed above. Suitable materials for golf ball core, intermediate and cover layers of the present invention include, but are not limited to, polyethylene, including, for example, low density polyethylene, linear low density polyethylene, and high density polyethylene; polypropylene; rubber-toughened olefin polymers; copolyether-esters; copolyether-amides; polycarbonates; acid copolymers which do not become part of an ionomeric copolymer; plastomers; flexomers; vinyl resins, such as those formed by the copolymerization of vinyl chloride with vinyl acetate, acrylic esters or vinylidene chloride; styrene/butadiene/styrene block copolymers; styrene/ethylene-butylene/styrene block copolymers; acrylonitrile-butadiene-styrene polymers; fluoropolymers; dynamically vulcanized elastomers; ethylene vinyl acetates; ethylene methacrylates and ethylene ethacrylates; ethylene methacrylic acid, ethylene acrylic acid, and propylene acrylic acid; polyvinyl chloride resins; copolymers and homopolymers produced using a metallocene or other single-site catalyst; polyamides, amide-ester elastomers, and graft copolymers of ionomer and polyamide, including, for example, Pebax® thermoplastic polyether block amides, commercially available from Arkema Inc; polyphenylene oxide resins or blends of polyphenylene oxide with high impact polystyrene, such as NORYL®, commercially available by General Electric Company of Pittsfield, Mass.; crosslinked transpolyisoprene blends; polyurethanes; polyureas; polyester-based thermoplastic elastomers, such as Hytrel®, commercially available from E.I. du Pont de Nemours and Company, and LOMOD®, commercially available from General Electric Company; polyurethane-based thermoplastic elastomers, such as Elastollan®, commercially available from BASF; natural and synthetic rubbers; partially and fully neutralized ionomers; and combinations thereof. Suitable golf ball materials and constructions also include, but are not limited to, those disclosed in U.S. Pat. Nos. 6,117,025, 6,767,940, and 6,960,630, the entire disclosures of which are hereby incorporated herein by reference.

Particularly preferred materials for outer cover layers of the present invention include castable reactive materials, preferably selected from aliphatic and aromatic thermoset polyurethanes and aliphatic and aromatic thermoset polyureas.

Additionally suitable cover layer materials and methods for forming them are further disclosed, for example, in U.S. Pat. Nos. 5,484,870, 6,818,724, and 6,835,794, the entire disclosures of which are hereby incorporated herein by reference.

For purposes of the present invention, compression is measured according to a known procedure, using an Atti compression test device, wherein a piston is used to compress a ball against a spring. The travel of the piston is fixed and the deflection of the spring is measured. The measurement of the deflection of the spring does not begin with its contact with the ball; rather, there is an offset of approximately the first 1.25 mm (0.05 inches) of the spring's deflection. Very low stiffness cores will not cause the spring to deflect by more than 1.25 mm and therefore have a zero compression measurement. The Atti compression tester is designed to measure objects having a diameter of 42.7 mm (1.68 inches); thus, smaller objects, such as golf ball cores, must be shimmed to a total height of 42.7 mm to obtain an accurate reading.

For purposes of the present invention, COR is determined according to a known procedure wherein a golf ball or golf ball subassembly (e.g., a golf ball core) is fired from an air cannon at a given velocity (125 ft/s for purposes of the present invention). Ballistic light screens are located between the air cannon and the steel plate to measure ball velocity. As the ball travels toward the steel plate, it activates each light screen, and the time at each light screen is measured. This provides an incoming transit time period inversely proportional to the ball's incoming velocity. The ball impacts the steel plate and rebounds though the light screens, which again measure the time period required to transit between the light screens. This provides an outgoing transit time period inversely proportional to the ball's outgoing velocity. COR is then calculated as the ratio of the incoming transit time period to the outgoing transit time period, COR=Tᵢₙ/Tₒᵤₜ.

### EXAMPLES

It should be understood that the examples below are for illustrative purposes only. In no manner is the present invention limited to the specific disclosures therein.

### Examples 1 and 2 and Comparative Examples 3 and 4

In Examples 1 and 2 compositions were prepared by mixing an acid polymer selected from Clarix® and Iotek®, calcium hydroxide, and zinc stearate in a twin screw extruder. The relative amounts of each component used are indicated in Table 1. The melt flow index, flexural modulus, and Shore D hardness of each composition were measured, and the results are reported in Table 1.

Clarix® and Iotek® are partially neutralized Na/Zn ethylene/acrylic acid ionomers comprising 10 wt %-15 wt % acid, commercially available from A. Schulman, Inc. and ExxonMobil Chemical Company, respectively.

Melt flow index was measured at the temperature given using a 2.16 kg weight according to ASTM D1238. Flexural modulus was measured using flex bars, which were prepared and measured according to ASTM D790. Hardness was measured according to ASTM D2240. In the tables below, “pph” is defined as parts per hundred parts of polymer.

TABLE 1

| | | | | | Melt | Melt | | |
|---|---|---|---|---|---|---|---|---|
| | | | | | Flow | Flow | | |
| | | | calcium | zinc | Index | Index | Flexural | |
| | Clarix ® | Iotek ® | hydroxide | stearate | (g/10 min | (g/10 min | Modulus | Hardness |
| Example | (parts) | (parts) | (pph) | (pph) | @190° C.) | @230° C.) | (kpsi) | (Shore D) |
| 1 | 100 | 0 | 2.83 | 20.0 | * | 0.4 | 48.5 | 59 |
| 2 | 0 | 100 | 3.34 | 30.0 | * | 0.6 | 50.7 | 58 |
| 3 | 100 | 0 | 0 | 0 | 1.7 | * | 46.3 | 59 |
| 4 | 0 | 100 | 0 | 0 | 1.8 | * | 52.7 | 59 |

* not measured

Each of the above compositions was injection molded to form a solid sphere having a diameter of 1.55 in (3.94 cm). The spheres were evaluated for compression, hardness, and COR at 125 ft/sec. The results are reported in Table 2.

TABLE 2

| | | Hardness | |
|---|---|---|---|
| Example | Compression | (Shore D) | COR |
| 1 | 142 | 60 | 0.785 |
| 2 | 141 | 60 | 0.807 |
| 3 | 153 | 66 | 0.757 |
| 4 | 153 | 65 | 0.760 |

When numerical lower limits and numerical upper limits are set forth herein, it is contemplated that any combination of these values may be used.

All patents, publications, test procedures, and other references cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A golf ball having at least one layer formed from a moisture resistant composition having a moisture vapor transmission rate (MVTR) of 12.5 g·mil/100 in²/day or less, a melt flow index of 1.0 g/10 min or higher, and comprising a highly neutralized acid polymer, wherein the highly neutralized acid polymer comprises from 0 wt % to 19 wt % of a softening monomer, based on the total weight of the polymer.

2. The golf ball of claim 1, wherein the golf ball core has a diameter of from 1.50 inches to 1.62 inches.

3. The golf ball of claim 2, wherein the cover has a thickness of from 0.025 inches to 0.090 inches and is formed from the moisture resistant composition.

4. The golf ball of claim 1, wherein the moisture resistant composition has a melt flow index of from 1.0 to 4.0 g/10 min.

5. The golf ball of claim 1, wherein the acid polymer is an ethylene/(meth)acrylic acid polymer comprising an alkyl(meth)acrylate in an amount of from 0 wt % to 19wt %, based on the total weight of the polymer.

6. The golf ball of claim 5, wherein the moisture resistant composition further comprises an organic acid salt selected from zinc stearate and calcium stearate.

7. The golf ball of claim 6, wherein 80% or more of the acid groups present in the moisture resistant composition are neutralized to salts.

8. The golf ball of claim 7, wherein 50% or more of the acid groups present in the moisture resistant composition are neutralized to salts having calcium and/or zinc counterions.

9. A golf ball having at least one layer formed from a moisture resistant composition having a moisture vapor transmission rate (MVTR) of 12.5 g·mil/100 in²/day or less, a melt flow index of 1.0 g/10 min or higher, and comprising a highly neutralized acid polymer, wherein the highly neutralized acid polymer comprises from 20 wt % to 50 wt % of a softening monomer, based on the total weight of the polymer.

10. The golf ball of claim 1, wherein the golf ball core has a diameter of from 1.50 inches to 1.62 inches and is formed from the moisture resistant composition

11. The golf ball of claim 9, wherein the acid polymer is an ethylene/(meth)acrylic acid polymer comprising an alkyl(meth)acrylate in an amount of from 20 wt % to 50 wt %, based on the total weight of the polymer.

12. The golf ball of claim 11, wherein the moisture resistant composition further comprises an organic acid salt selected from zinc stearate and calcium stearate.

13. The golf ball of claim 12, wherein 80% or more of the acid groups present in the moisture resistant composition are neutralized to salts.

14. The golf ball of claim 13, wherein 50% or more of the acid groups present in the moisture resistant composition are neutralized to salts having calcium and/or zinc counterions.

15. A multi-layer golf ball comprising a core having a diameter of 1.50 inches, an inner cover layer having a thickness of from 0.025 inches to 0.060 inches, and an outer cover layer having a thickness of from 0.025 inches to 0.060 inches, wherein at least one of the core, the inner cover layer, and the outer cover layer is formed from a moisture resistant composition having a moisture vapor transmission rate (MVTR) of 12.5 g·mil/100 in²/day or less, a melt flow index of 1.0 g/10 min or higher, and comprising a highly neutralized acid polymer.

16. The golf ball of claim 15, wherein the core is formed from the moisture resistant composition, and wherein the acid polymer is an ethylene/(meth)acrylic acid polymer comprising an alkyl(meth)acrylate in an amount of from 20 wt % to 50 wt %, based on the total weight of the polymer.

17. The golf ball of claim 15, wherein the inner cover layer is formed from the moisture resistant composition, and wherein the acid polymer is an ethylene/(meth)acrylic acid polymer comprising an alkyl(meth)acrylate in an amount of from 0 wt % to 19 wt %, based on the total weight of the polymer.

18. The golf ball of claim 17, wherein the moisture resistant composition further comprises an organic acid salt selected from zinc stearate and calcium stearate.

19. The golf ball of claim 18, wherein 80% or more of the acid groups present in the moisture resistant composition are neutralized to salts.

20. The golf ball of claim 19, wherein 50% or more of the acid groups present in the moisture resistant composition are neutralized to salts having calcium and/or zinc counterions.
